(19) United States
(12) Patent Application Publication
(10) Pub. No.: US 2014/0049392 A1
(43) Pub. Date: Feb. 20, 2014

(54) Method of preventing spoilage

(71) Applicant: Ronald E. Wagner, Fleming Island, FL (US)

(72) Inventor: Ronald E. Wagner, Fleming Island, FL (US)

(73) Assignee: BAE Systems Information and Electronic Systems Integration, Inc.

(21) Appl. No.: 12/807,922

(22) Filed: Sep. 16, 2010

Related U.S. Application Data
(60) Provisional application No. 61/342,132, filed on Apr. 9, 2010.

(51) Int. Cl. G08B 21/00

(52) U.S. Cl. 340/540

(57) ABSTRACT

A method is provided for preventing spoilage of perishable goods by utilizing algorithms that predict the probability of spoilage based on sensor inputs, in which containers are provided with one or more spoilage sensors that are output to a prognostic or detection algorithm for providing the probability that spoilage has occurred or the probability that spoilage will occur at some specific time in the future.

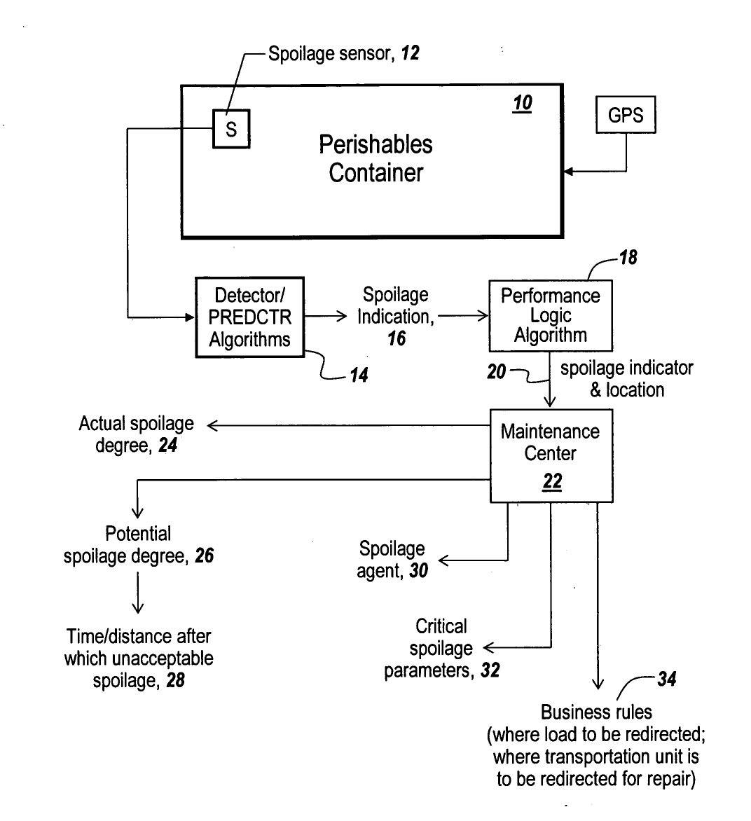

### RELATED APPLICATIONS

This Application claims rights under 35 USC §119(e) from U.S. Application Ser. No. 61/342,132 filed Apr. 9, 2010, the contents of which are incorporated herein by reference.

### FIELD OF THE INVENTION

This invention relates to the transport of perishable goods and more particularly to a method of preventing spoilage or the delivery of spoiled goods by prediction of spoilage.

### BACKGROUND OF THE INVENTION

As will be appreciated in the transportation of perishables, produce shippers have the responsibility for the product to make sure that the perishable product arrives in tact and without spoilage. In the past there has been no adequate control of the environment that perishable freight is shipped through, and sensors that are utilized for instance to sense temperature by itself do not offer the opportunity to mitigate losses suffered due to spoilage.

Moreover, one could measure other parameters than temperature such as listeria that is evolved from foods. Additionally, sensors can be utilized to sense chemical emanations from foods. It is noted that while certain foods are temperature sensitive, some other foods are sensitive to, for instance, vibration and other environmental factors such as humidity and the ambient environment. If one could measure a variety of parameters it would be possible to know that there is a potential for spoilage, that spoilage has occurred or that a transport unit for instance needs to be either fixed or diverted to a closer port so that the cargo arrives unspoiled.

### SUMMARY OF INVENTION

In order to mitigate against spoilage, in the subject invention spoilage is predicted utilizing a number of sensors within a transportation refrigeration unit (TRU), with the outputs of the sensors being provided as inputs to a prognostication or predication algorithm that analyzes the data and provides a guess or prognostication as to any spoilage which may be currently occurring, or which predicts when spoilage will occur, given the sensed conditions.

There are various prognostication algorithms that are available for use, one of which is described in U.S. patent application Ser. No. 12/548,683 by Carolyn Spier filed on Aug. 27, 2009, assigned to the assignee hereof and incorporated herein by reference.

It is therefore one of the aspects of the subject invention to provide prognostication algorithms and suitable sensors to detect the onset of spoilage and to detect spoilage itself. The sensors involved in the subject invention are in addition to the sensors that the Food and Drug Administration requires for intermodal transport units. It is noted that the FDA required sensors are not adequate to determine spoilage. Nor are they sensitive enough to sense the onset of spoilage. Moreover, if temperature is not uniform throughout a transportation refrigeration unit or airflow is not uniform throughout the unit, while there may be some product which is good, other product may be spoiled and it is not known when product is spoiled until it is unloaded.

In order to provide the prognostication function sensors are embedded close to the point of performance, for instance on a pallet in a reusable bulk container. By embedding numbers of sensors within a container one can obtain a better understanding of the conditions inside the container and thus the transportation unit.

Having the appropriate sensors scattered throughout the transportation unit, it is a portion of the subject invention to bring data into an embedded prognostication algorithm at the point of performance and to detect the presence of deleterious or bad agents, or emanations which would indicate spoilage. By providing a prognostication algorithm directly at the container one can, through the use of microprocessors, determine from the sensed data that spoilage is occurring or will be occurring in the near future; and transmit such information to a fleet management office.

The algorithms utilized at the point of performance for spoilage protection are either detection algorithms or prediction algorithms. To this can be added a performance logic algorithm which could be set up with basic business rules that would specify, inter alia, where a load is to be directed, where for instance the transportation unit can be directed to the nearest repair depot, instead of sending the unit with the spoiled goods to the customer.

Thus, the subject system is a method of preventing or predicting spoilage through the use of prognostication.

In summary, a method is provided for preventing spoilage of perishable goods by utilizing algorithms that predict the probability of spoilage based on sensor inputs, in which containers are provided with one or more spoilage sensors that are output to a prognostic or detection algorithm for providing the probability that spoilage has occurred or the probability that spoilage will occur at some specific time in the future.

### BRIEF DESCRIPTION OF THE DRAWINGS

These and other features of the subject invention will be better understood in connection with the Detailed Description, in connection with the sole Drawing FIGURE, of which:

The sole Drawing FIGURE is a diagrammatic illustration of a spoilage predication and monitoring system in which a perishable's container is provided with a spoilage sensor coupled to a prognostication algorithm that indicates spoilage, optionally provided to a performance logic algorithm to apply business rules, with the output coupled to a maintenance center to indicate to management the actual spoilage degree or potential spoilage degree, as well as for instance spoilage agents and critical spoilage parameters, along with the optional business rules to be applied for a particular transportation unit.

### DETAILED DESCRIPTION

Referring now to the sole drawing FIGURE, a perishable container 10 includes one or more spoilage sensors 12, the output of which is applied as an input to a prognostication and detection algorithm 14. The output of this algorithm is a spoilage indication 16 which in one embodiment is coupled to a performance logic algorithm 18 such as described in U.S. patent application Ser. No. 12/660,209 by Ronald Wagner filed on Feb. 23, 2010, assigned to the assignee hereof and incorporated herein by reference.

If the performance logic algorithm is utilized, a spoilage indicator and location is available as an input 20 to a maintenance center 22.

The maintenance center takes the information that has been transmitted to it and provides as an output in one embodiment, the actual spoilage degree 24, or the potential spoilage degree 26. In addition to the potential spoilage degree, the time and/or distance before which unacceptable spoilage exists is displayed as illustrated at 28. Also if the spoilage has occurred because of a spoilage agent, the spoilage agent 30 is displayed, whereas critical spoilage parameters derived from prognostication algorithms may be displayed at 32. Finally, as illustrated at 34, the business rules applicable to the particular shipment as derived from the performance logic algorithm 18 may be displayed to indicate for instance where the load is to be redirected, or where the transportation unit is to be redirected for repair.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

1. A method for minimizing the effect of spoilage of perishables transported in a container, comprising the steps of:
providing a container spoilage sensors for continuous monitoring;
coupling the output of the spoilage sensors to a prognostication algorithm at the container that predicts the time to the onset of spoilage in terms of predicted spoilage potential onset time dependent on values from the spoilage sensors;
outputting the predicted spoilage potential from the prognostication algorithm;
determining from the outputted potential for spoilage a course of action for the shipment of the container taking into account the location of the container, the potential for spoilage, the predicted time to actual spoilage and the distance to a delivery location to minimize the effects of spoilage and,
implementing routing changes to a delivery location closer than an original delivery location to the current location of the container, the delivery location based upon the determined course of action.

2. (canceled)

3. The method of claim 1, wherein the spoilage sensor includes an indication of a spoilage occurrence.

4. (canceled)

5. The method of claim 1, wherein the spoilage sensor includes an airflow sensor.

6. The method of claim 1, wherein the spoilage sensor includes a temperature sensor.

7. The method of claim 1, wherein the spoilage sensor includes a chemical sensor.

8. The method of claim 1, wherein the sensor includes a biologic sensor.

9. (canceled)

10. The method of claim 1, wherein the prognostication algorithm is embedded in a processor at the container.

11. The method of claim 1, wherein the container is a reusable bulk container.

12. The method of claim 1, and further including providing a geophysical position sensor at the container and wherein the spoilage indication includes an indication of the location of the container based on an output from the geophysical position sensor.

13. The method of claim 1, and further including transmitting the predicted potential spoilage indication to a remote location.

14. The method of claim 13, wherein the remote location includes a fleet management facility.

15. The method of claim 1, and wherein determining of a course of action includes an algorithm containing basic business rules for the transport of the perishables and wherein responsive to the result of the prognostication algorithm, the basic business rules algorithm provides for a re-routing of the container.

16. The method of claim 15, wherein the re-routing decisions are based on at least one of actual spoilage degree, potential spoilage degree and container location.

17. The method of claim 1, and further including providing a performance logic algorithm to provide business rules based on predicted potential spoilage to specify redirection of either the perishables or the container.
